(19) United States
(12) Patent Application Publication
(10) Pub. No.: US 2005/0173821 A1
(43) Pub. Date: Aug. 11, 2005

(54) Method for making an outsole having a tread member

(76) Inventor: Kun-Chung Liu, Taichung Hsien (TW)

Correspondence Address: TROP PRUNER & HU, PC, 8554 KATY FREEWAY, SUITE 100, HOUSTON, TX, 77024, US

(21) Appl. No.: 10/772,506

(22) Filed: Feb. 5, 2004

(51) Int. Cl. B29C 44/06

(52) U.S. Cl. 264/45.1

(57) ABSTRACT

A method for making an outsole having a tread member includes the steps of: (a) preparing an abrasive-resistant blank sheet for the tread member; (b) preparing a mold including lower and upper mold parts separably closed to each other, one of the lower and upper mold parts having a mold cavity, a cavity bottom formed in the mold cavity, and a plurality of tread patterning grooves formed in the cavity bottom; (c) laying the blank sheet on the cavity bottom in the mold cavity to span the tread patterning grooves; (d) introducing a molten foamable material into the mold cavity; and (e) causing the molten foamable material and the blank sheet to undergo cross-linking and foaming reactions under heat and pressure.

### BACKGROUND OF THE INVENTION

1. Field of the Invention

The invention relates to a method for making an outsole, more particularly to a method for making an outsole having an abrasive-resistant tread member.

2. Description of the Related Art

Referring to FIG. 1, a conventional method for making an outsole having at least one tread member is conducted with the use of a mold 2. The mold 2 includes upper and lower mold parts 202,201, and is kept at a temperature ranging from 170 to 190° C. The lower mold part 201 has a mold cavity 203, and a plurality of separating walls 204 defining a plurality of receiving recesses 205 on a bottom surface of the mold cavity 203.

When making the outsole, a plurality of blank sheets 1 are anchored within the receiving recesses 205, respectively. The mold 2 is closed, and a major material different from the blank sheets 1 in density, hardness, resiliency and color is injected into the mold cavity 203. After undergoing cross-linking and foaming reactions, the major material integrates with the blank sheets 1 to form the outsole.

Although the aforesaid method can be used to make the outsole having at least one tread member, it has the following shortcomings:

1. Since the mold 2 is kept at a temperature sufficient for undergoing the cross-linking and foaming reactions (i.e., 170-190° C.), and since each of the blank sheets 1 should be anchored within a respective one of the receiving recesses 205 in a precise manner, premature cross-linking and foaming reactions can occur in the blank sheets 1 before the major material is injected into the mold cavity 203. Furthermore, the blank sheets 1 are liable to deform. Particularly, a part of each of the blank sheets 1, which is undergoing the cross-linking and foaming reactions, can move out of the respective receiving recess 205 when the major material is injected into the mold cavity 203.

2. It is time-consuming and relatively dangerous to precisely anchor each of the blank sheets 1 within the corresponding one of the receiving recesses 205 at an elevated temperature of the mold 2.

3. The configuration of each of the receiving recesses 205 should be designed according to the size of each of the blank sheets 1. The size of each of the blank sheets 1 should be changed according to the size of the outsole. Therefore, it is relatively troublesome to prepare the blank sheets 1 specified for a desired outsole.

### SUMMARY OF THE INVENTION

Therefore, the object of the present invention is to provide a method for making an outsole having an abrasive-resistant tread member in a relatively simple manner.

The method for making an outsole having a tread member according to this invention includes the steps of: (a) preparing an abrasive-resistant blank sheet for the tread member; (b) preparing a mold including lower and upper mold parts separably closed to each other, one of the lower and upper mold parts having a mold cavity, a cavity bottom formed in the mold cavity, and a plurality of tread patterning grooves formed in the cavity bottom; (c) laying the blank sheet on the cavity bottom in the mold cavity to span the tread patterning grooves; (d) introducing a molten foamable material into the mold cavity of the mold; and (e) causing the molten foamable material and the blank sheet to undergo cross-linking and foaming reactions under heat and pressure.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic sectional view of a mold used in a conventional method for making an outsole having at least one tread member;

FIG. 2 is a flow diagram of the first preferred embodiment of a method for making an outsole having a tread member according to this invention;

FIGS. 3 and 4 are schematic sectional views illustrating the steps of the method of the first preferred embodiment;

FIG. 5 is a schematic view of an outsole made using the method of the first preferred embodiment; and

FIG. 6 is a perspective view of blank sheets used in the second preferred embodiment of the method for making an outsole according to this invention; and

FIG. 7 is a sectional view to illustrate the method of the second preferred embodiment.

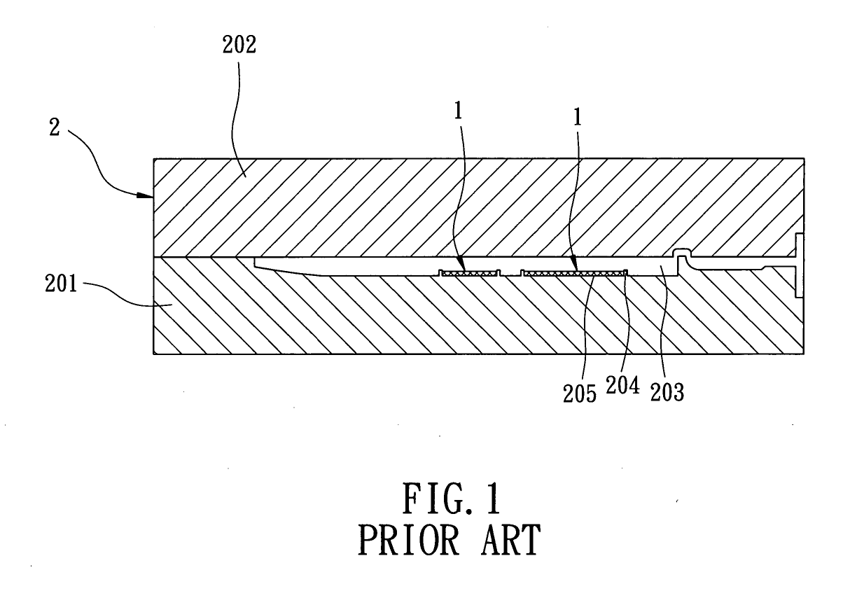

### DETAILED DESCRIPTION OF THE PREFERRED EMBODIMENTS

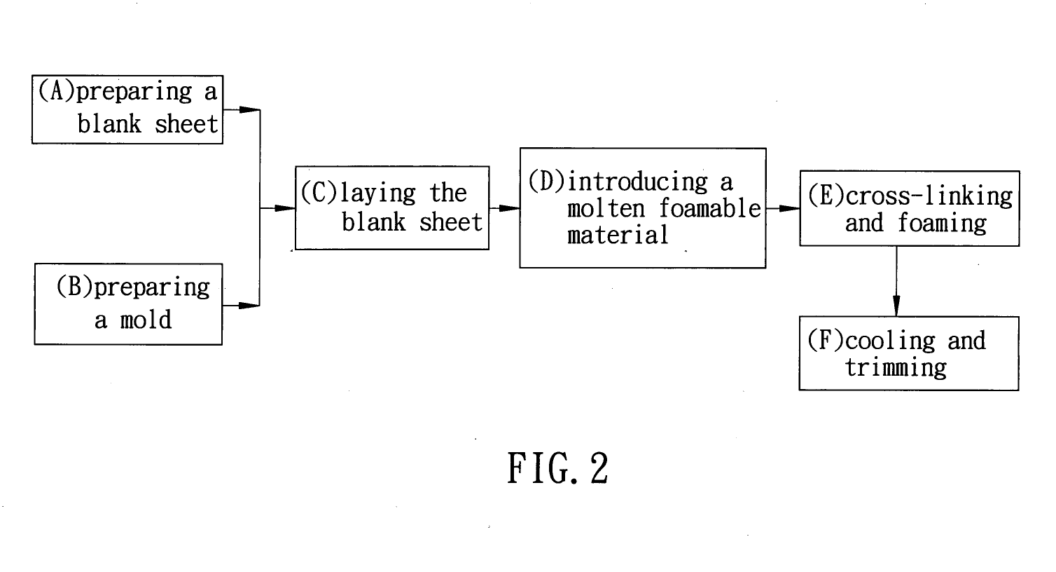

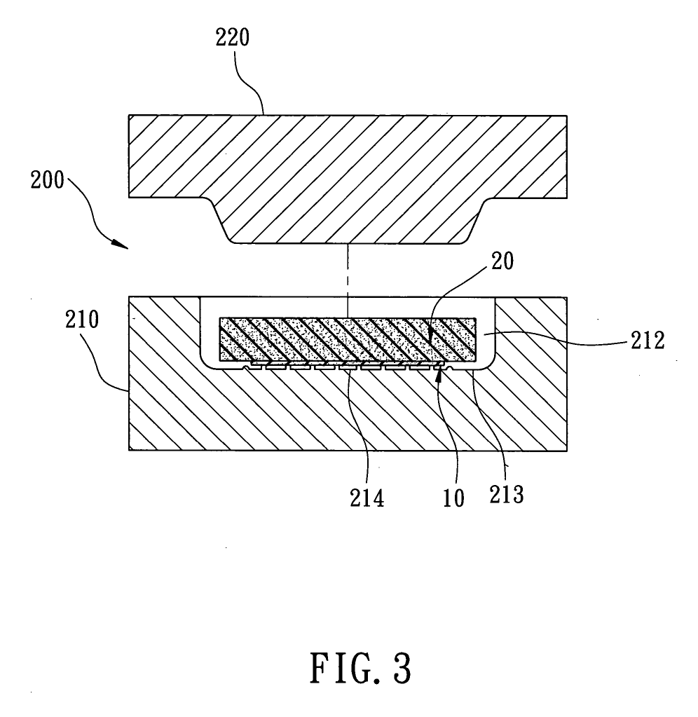

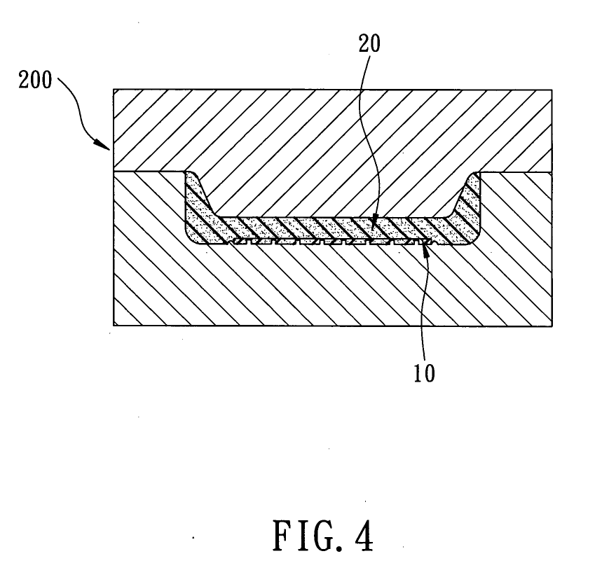

Referring to FIGS. 2, 3 and 4, the first preferred embodiment of the method for making an outsole having a tread member according to this invention includes the steps of:
A) preparing a blank sheet:

At least one blank sheet 10 is prepared for the tread member. The blank sheet 10 is preferably made of ethylene vinyl acetate copolymer, and has properties, such as relative rigidity, abrasive-resistance, and anti-slipping. The properties of the blank sheet 10 can be controlled by mixing it with any suitable synergist. In this preferred embodiment, the blank sheet 20 is configured as a flat sheet.
B) preparing a mold:

The mold 200 includes lower and upper mold parts 210,220 separably closed to each other. The lower mold part 210 has a mold cavity 212, a cavity bottom 213 formed in the mold cavity 212, and a plurality of tread patterning grooves 214 formed in the cavity bottom 213. The mold 200 is kept at a temperautre ranging from 150 to 180° C. during the processing.
C) laying the blank sheet:

The blank sheet 10 is laid on the cavity bottom 213 in the mold cavity 212 to span the tread patterning grooves 214.
D) introducing a molten foamable material:

A molten foamable material 20 is introduced into the mold cavity 212 of the mold 200. Preferably, the molten foamable material 20 is made of ethylene vinyl acetate copolymer having the same color as and different physical properties from the ethylene vinyl acetate copolymer for the blank sheet 10. The molten foamable material 20 is metered at a temperature ranging from 80° C. to 100° C. into the mold cavity 212 before the mold 200 is closed.
E) cross-linking and foaming:

The upper mold part 220 is moved toward the lower mold part 210 until the mold 200 is closed, and the molten foamable material 20 and the blank sheet 100 are caused to undergo cross-linking and foaming reactions under heat and pressure.
F) cooling and trimming:

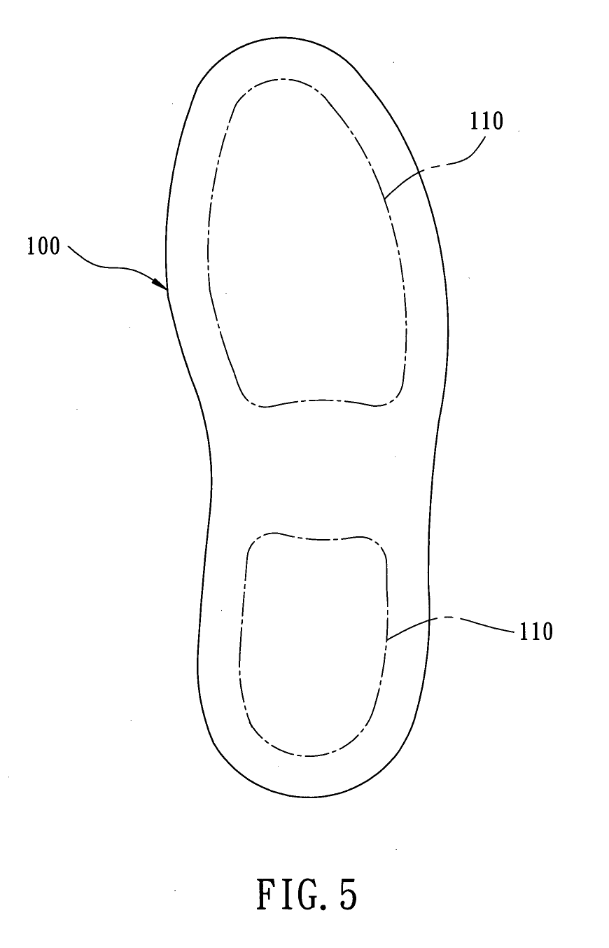

Referring to FIG. 5, after completing the cross-linking and foaming reactions, the mold 200 is opened to remove a semi-product of the outsole. The semi-product is then cooled and trimmed so as to result in the outsole 100, which has the abrasive-resistant tread members 110. Since the blank sheet 10 and the molten foamable material 20 have the same color, it is not necessary to position the blank sheet 10 in the lower mold part 210 precisely as required in the prior art. The aforesaid shortcomings of the prior art are thus avoided.

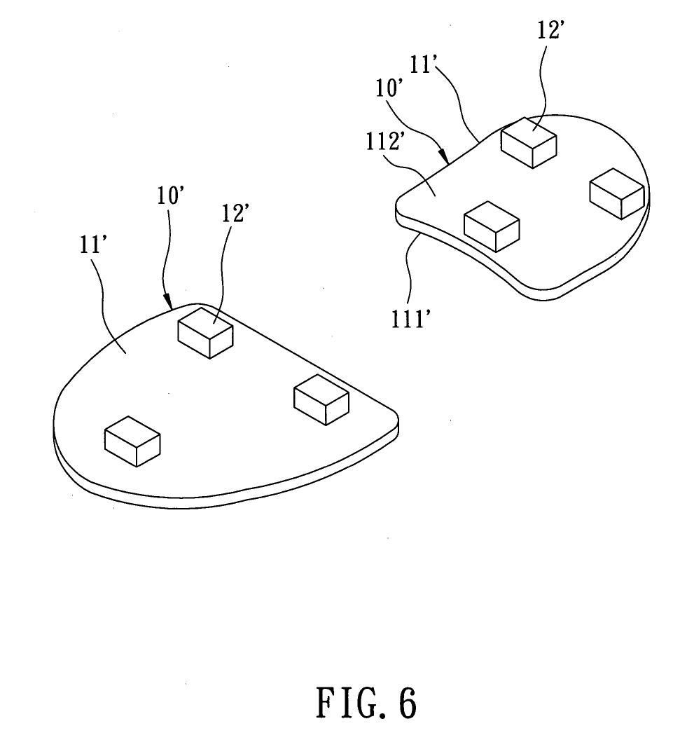

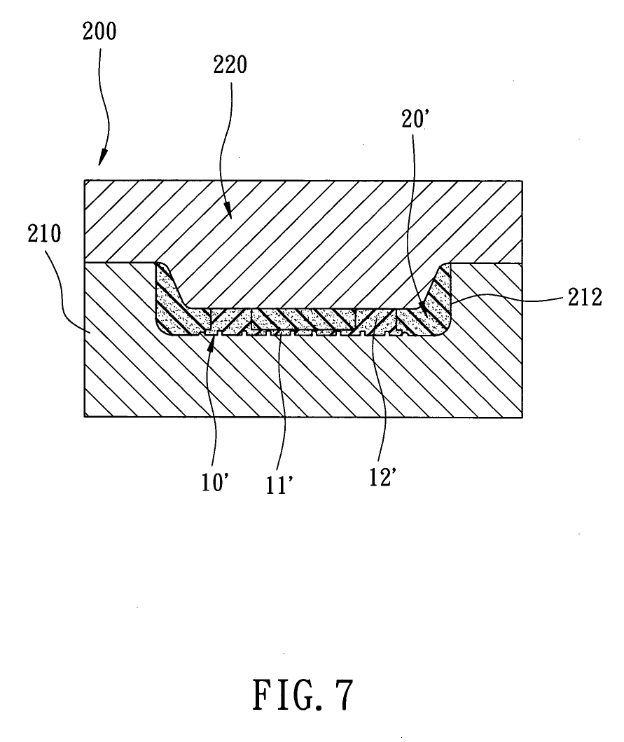

Referring to FIGS. 6 and 7, the second preferred embodiment of the method according to this invention is shown to be similar to the first preferred embodiment, except that the blank sheet 10′ includes a flat sheet 11′ which has a tread face 111′ and a joint face 112′, and a plurality of flanges 12′ protruding from the joint face 112′, and that the molten foamable material 20′ is injected into the mold cavity 212 after the mold 200 is closed. In the second preferred embodiment, the flanges 12′ of the blank sheet 10′ abut against the upper mold part 220 when the mold 200 is closed. Therefore, the blank sheet 10′ is positioned within the mold cavity 212 so as to prevent the blank sheet 10′ from moving and deforming when the molten foamable material 20′ is injected into the mold cavity 212.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

1. A method for making an outsole having a tread member, said method comprising the steps of:
(a) preparing an abrasive-resistant blank sheet for the tread member;
(b) preparing a mold including lower and upper mold parts separably closed to each other, one of said lower and upper mold parts having a mold cavity and a cavity bottom formed in said mold cavity;
(c) laying said blank sheet on said cavity bottom in said mold cavity;
(d) introducing a molten foamable material into said mold cavity of said mold; and
(e) causing said molten foamable material and said blank sheet to undergo cross-linking and foaming reactions under heat and pressure,
wherein said abrasive-resistant blank sheet is made of a first ethylene vinyl acetate copolymer material, and said molten foamable material is made of a second ethylene vinyl acetate copolymer having the same color as and different physical properties from said first ethylene vinyl acetate copolymer.

2. The method as claimed in claim 1, wherein said blank sheet is configured as a flat sheet, said molten foamable material being metered at a temperature ranging from 80° C. to 100° C. into said mold cavity before said mold is closed.

3. The method as claimed in claim 1, wherein said blank sheet includes a flat sheet which has a tread face and a joint face, and at least one flange protruding from said joint face, said molten foamable material being injected into said mold cavity after said mold is closed.
